(19) United States
(12) Patent Application Publication
(10) Pub. No.: US 2025/0215888 A1
(43) Pub. Date: Jul. 3, 2025

(54) UNDERWATER VACUUM CLEANER IMPELLER

(71) Applicant: Poolelf Smart Technology Co., Ltd., HUAIAN (CN)

(72) Inventor: XIN CAO, Ningbo City (CN)

(21) Appl. No.: 19/001,199

(22) Filed: Dec. 24, 2024

(30) Foreign Application Priority Data
Dec. 29, 2023 (CN) 2023118503771

(51) Int. Cl. F04D 29/28; C02F 1/00; F04D 17/08; F04D 29/42; F04D 29/44

(52) U.S. Cl. CPC F04D 29/281; C02F 1/001; F04D 17/08; F04D 29/4206; F04D 29/441; C02F 2301/063

(57) ABSTRACT

The present invention discloses an underwater vacuum cleaner impeller, and relates to the field of underwater vacuum cleaners. The underwater vacuum cleaner impeller includes a vacuum cleaner body, and an improved impeller mounted inside the vacuum cleaner body. The improved impeller includes a mounting base mounted inside the vacuum cleaner body, and a rotary head is rotatably disposed inside the mounting base. An arc-shaped vortex blade is mounted on a back surface of the rotary head, and a guide nozzle is mounted on an end of the arc-shaped vortex blade. In the underwater vacuum cleaner impeller, by starting a drive motor, the rotary head drives the arc-shaped vortex blade to rotate, and a water drainage amount of the single-cavity arc-shaped vortex blade is larger.

### CROSS REFERENCE TO RELATED APPLICATIONS

The present application claims the priority of Chinese patent application No. 2023118503771, filed on Dec. 29, 2023, and contents of which are incorporated herein by reference.

### BACKGROUND OF THE INVENTION

### Field of the Invention

The present invention relates to the technical field of underwater vacuum cleaners, and in particular to an underwater vacuum cleaner impeller.

### Description of Related Art

An underwater vacuum cleaner is a filtering cleaning device used for cleaning impurities in water, and the principle thereof is that water is suctioned into the device through an impeller and then directionally drained from a water outlet end. The water quality is filtered by mounting a filtering component at the water outlet end, so as to achieve continuous water circulation and filtering in the water. In addition to a structural arrangement of a filter screen, an underwater dust removal effect of the underwater vacuum cleaner is greatly determined by an impeller effect.

A current underwater vacuum cleaner impeller is mostly a structure including fan blades annularly arranged, a space between every two of the fan blades is a drainage space. When a water body is directionally pumped and drained, the water body is directionally transferred through each drainage space. However, in actual use, since a single drainage space is very small, a radial flow is relatively small, the overall water throwing amount is limited. If a pumping and drainage power is wanted to be increased, the impeller needs to be designed to be larger, the cost and the space are correspondingly increased, and thus an underwater vacuum cleaner impeller is provided for solving the above problems.

### SUMMARY OF THE INVENTION

In view of the shortcomings of the prior art, the present invention provides an underwater vacuum cleaner impeller, which solves the problems that the current underwater vacuum cleaner impeller is mostly a structure including fan blades annularly arranged, the space between every two of the fan blades is the drainage space, when the water body is directionally pumped and drained, the water body is directionally transferred through each drainage space, but in actual use, since the single drainage space is very small, the radial flow is relatively small, the overall water throwing amount is limited, and if the pumping and drainage power is wanted to be increased, the impeller needs to be designed to be larger, the cost and the space are correspondingly increased.

In order to achieve the above object, the present invention is implemented by the following technical solutions. An underwater vacuum cleaner impeller, including: a vacuum cleaner body; and an improved impeller mounted inside the vacuum cleaner body, in which the improved impeller includes
a mounting base mounted inside the vacuum cleaner body,
a rotary head mounted inside the mounting base through a bearing,
an arc-shaped vortex blade disposed on a back surface of the rotary head, and configured to rotate with the rotary head to directionally push a fluid, and
a guide nozzle mounted on an end of the arc-shaped vortex blade by a bolt.

Preferably, the vacuum cleaner body includes
a machine head mounted with the improved impeller inside, and a feed nozzle and a discharge pipe on an outer surface thereof,
an upper housing and a lower housing respectively mounted on upper and lower sides of a tip end of the machine head, and
a drive motor mounted between the upper housing and the lower housing and configured to drive the rotary head to rotate.

Preferably, the machine head includes
a circular cover mounted on an outer surface of the mounting base,
a feed connector disposed on an outer peripheral wall of the circular cover and connected to the feed nozzle, and
a discharge connector disposed on a tip end of the circular cover and connected to the discharge pipe.

Preferably, the feed connector includes
a flange seat integrally formed on an outer side of the circular cover,
a connecting sleeve mounted on an outer surface of the flange seat, and
a guide connector mounted on the feed nozzle and movably engaged with the connecting sleeve.

Preferably, an outer wall of the flange seat is provided with a connecting groove, an end of the connecting sleeve is provided with a screw-in clamping member, the screw-in clamping member penetrates through the connecting groove, the outer surface of the flange seat is provided with a limiting column, and the limiting column is movably engaged with one side of the screw-in clamping member.

Preferably, an end of the guide connector is provided with an elastic clamping member, and the elastic clamping member is movably engaged in an inner side wall of the connecting sleeve.

Preferably, the rotary head is provided with a clamping groove inside, an output end of the drive motor is mounted with a transmission clamping member, and the transmission clamping member is movably inserted into the clamping groove.

Preferably, a rotary plate is fixedly connected to the back surface of the rotary head, and the arc-shaped vortex blade is integrally formed on an outer surface of the rotary plate.

Preferably, a connecting pipe is rotatably connected to an end of the guide nozzle, and fixedly mounted inside the discharge connector.

The present invention discloses an underwater vacuum cleaner impeller, which has the following beneficial effects.

1. In the underwater vacuum cleaner impeller, by starting the drive motor, the output end of the drive motor drives the transmission clamping member to rotate. At this time, the transmission clamping member drives the rotary head to rotate, so that the rotary head drives the arc-shaped vortex blade to rotate, and a water drainage amount of the single-cavity arc-shaped vortex blade is larger. During the rotation process, water at one end of the feed nozzle is suctioned, and then drained from one end of the guide nozzle into the discharge pipe, so as to realize circulation pumping and drainage of a water body under water. During this process, a dust suction and filtration effect can be realized by mounting a filter member, and compared with a traditional multi-blade impeller, the improved impeller has a stronger water throwing capability, a small volume, and a low cost.

2. In the underwater vacuum cleaner impeller, the screw-in clamping member at the end of the connecting sleeve is rotated to enter the inside of the connecting groove, the inner side wall of the screw-in clamping member is movably engaged with the limiting column, then one end of the guide connector is mounted on the feed nozzle, and the other end of the guide connector is engaged inside the connecting sleeve through the elastic clamping member, thereby completing the mounting, which is convenient for the insertion and disassembly of the feed nozzle and the discharge pipe.

3. In the underwater vacuum cleaner impeller, the mounting base is mounted inside the circular cover by the bolt, then the drive motor is mounted inside the lower housing, the transmission clamping member at the output end of the drive motor is inserted into the clamping groove, and then the upper housing is mounted on an outer surface of the drive motor, and thus the assembly is convenient.

### BRIEF DESCRIPTION OF THE DRAWINGS

In order to illustrate examples of the present invention or technical solutions in the related art more clearly, the drawings needed to be used in the examples or the related art will be briefly introduced below. Obviously, the drawings in the following description are merely some examples in the present invention. Those having ordinary skills in the art can obtain other drawings based on these drawings without exerting creative work.

FIG. 1 is a schematic structural diagram of an overall outer surface of the present invention.

FIG. 2 is an exploded view of a structure of an outer surface of a vacuum cleaner body of the present invention.

FIG. 3 is a schematic structural diagram of an outer surface of a machine head of the present invention.

FIG. 4 is an exploded view of a structure of the outer surface of the machine head of the present invention.

FIG. 5 is a schematic structural diagram of an end of the machine head of the present invention.

FIG. 6 is a schematic structural diagram of an outer surface of a mounting base of the present invention.

FIG. 7 is a schematic structural diagram of a back surface of a circular cover of the present invention.

FIG. 8 is a schematic structural diagram of an outer surface of an arc-shaped vortex blade of the present invention.

FIG. 9 is a schematic diagram of an overall structure of the arc-shaped vortex blade of the present invention.

### REFERENCE SIGNS LIST

1: feed nozzle, 2: vacuum cleaner body, 21: upper housing, 22: drive motor, 23: lower housing, 24: improved impeller, 241: rotary head, 242: mounting base, 243: connecting pipe, 244: rotary plate, 245: clamping groove, 246: arc-shaped vortex blade, 247: guide nozzle, 25: machine head, 251: circular cover, 252: discharge connector, 253: feed connector, 2531: flange seat, 2532: connecting groove, 2533: connecting sleeve, 2534: screw-in clamping member, 2535: guide connector, 2536: elastic clamping member, 2537: limiting column, 26: transmission clamping member, 3: discharge pipe

### DETAILED DESCRIPTION OF THE INVENTION

In order to make purposes, technical solutions, and advantages of an embodiment of the present invention clearer, the technical solutions in the embodiment of the present invention are clearly and completely described. Obviously, the described embodiment is part of embodiments of the present invention, not all of the embodiments. Based on the embodiment of the present invention, all other embodiments obtained by those having ordinary skills in the art without creative work fall within the protection scope of the present invention.

The embodiment of the present application provides an underwater vacuum cleaner impeller, which solves the problems that a current underwater vacuum cleaner impeller is mostly a structure including fan blades annularly arranged, a space between every two of the fan blades is a drainage space, when a water body is directionally pumped and drained, the water body is directionally transferred through each drainage space, but in actual use, since a single drainage space is very small, a radial flow is relatively small, the overall water throwing amount is limited, and if a pumping and drainage power is wanted to be increased, an impeller needs to be designed to be larger, the cost and the space are correspondingly increased.

In order to better understand the above technical solutions, the above technical solutions will be described in detail below with reference to the accompanying drawings and specific embodiments.

The embodiment of the present invention discloses an underwater vacuum cleaner impeller.

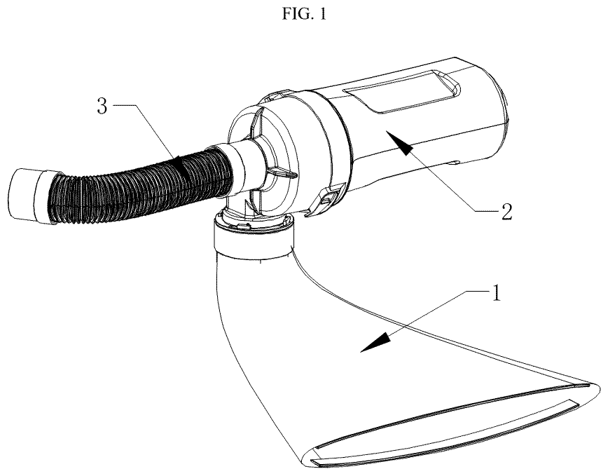

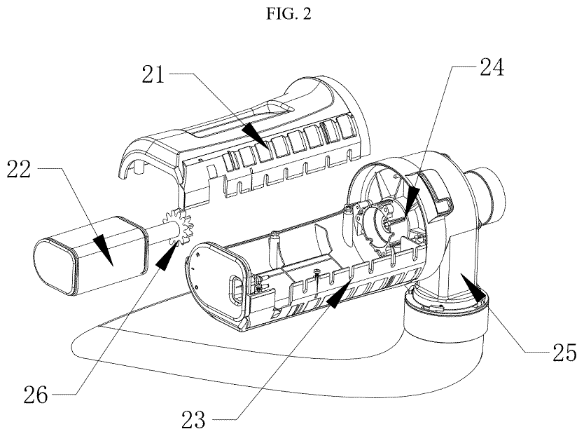

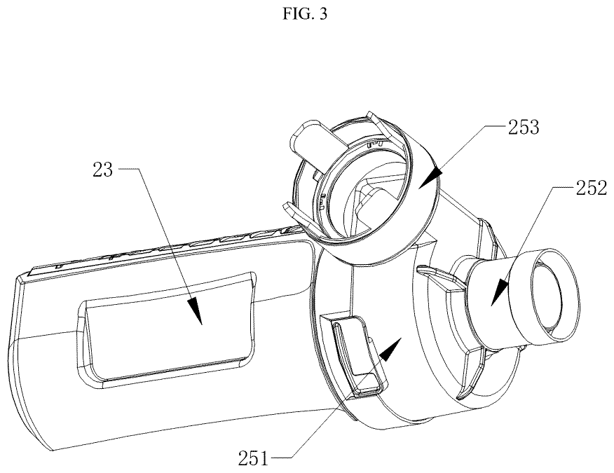

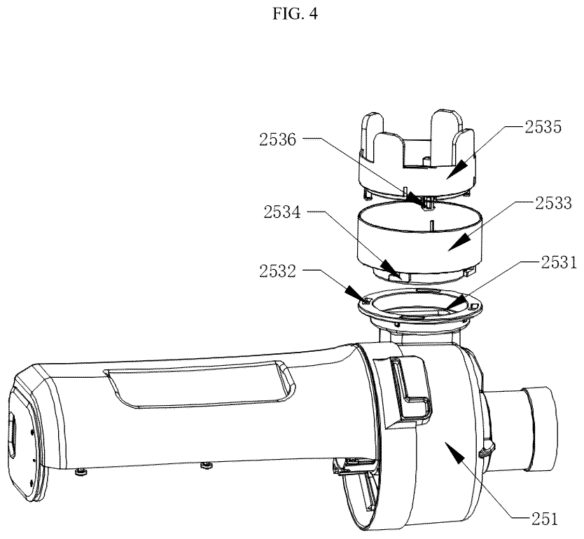

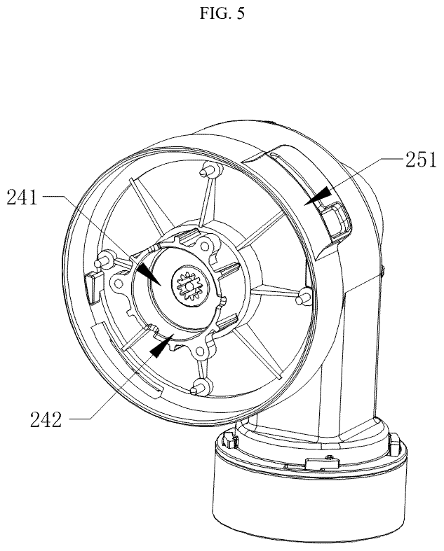

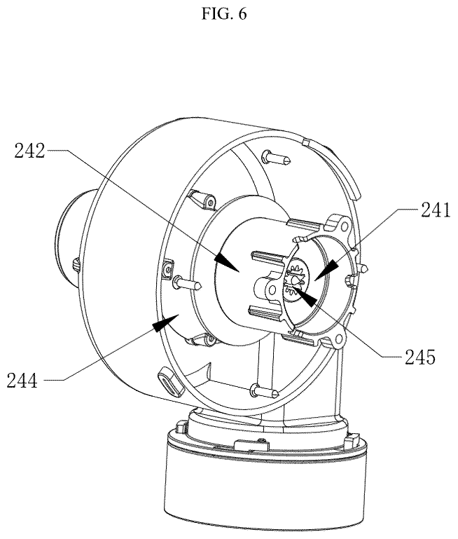

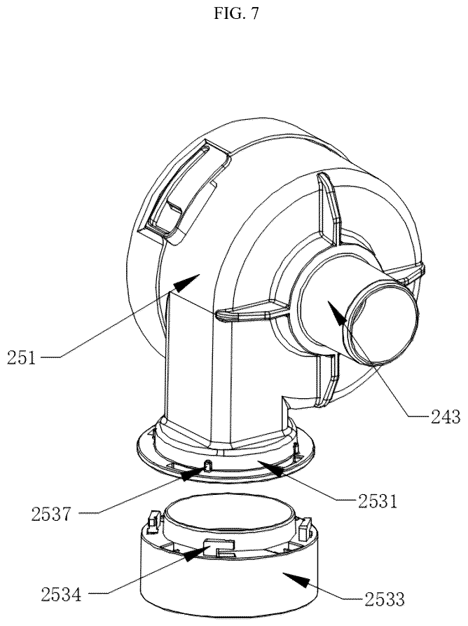

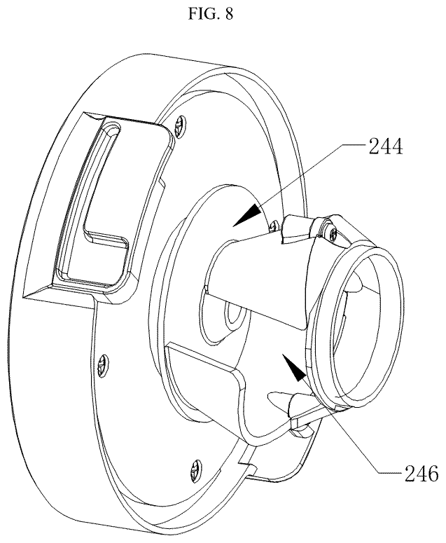

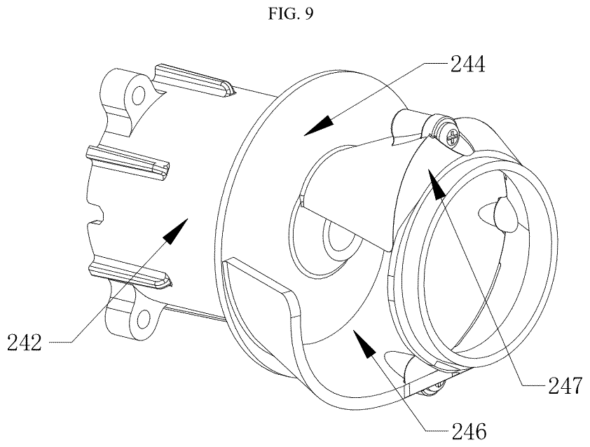

As shown in FIGS. 1 to 9, a vacuum cleaner body 2 and an improved impeller 24 mounted inside the vacuum cleaner body 2 are included. The improved impeller 24 includes
a mounting base 242 mounted inside the vacuum cleaner body 2,
a rotary head 241 mounted inside the mounting base 242 through a bearing,
an arc-shaped vortex blade 246 disposed on a back surface of the rotary head 241, and configured to rotate with the rotary head 241 to directionally push a fluid, and
a guide nozzle 247 mounted on an end of the arc-shaped vortex blade 246 by a bolt. A water drainage amount of the single-cavity arc-shaped vortex blade 246 is larger. During the rotation process, water at one end of a feed nozzle 1 is suctioned, and then drained from one end of the guide nozzle 247. Compared with a traditional multi-blade impeller, the improved impeller 24 has a stronger water throwing capability, a small volume, and a low cost.

The vacuum cleaner body 2 includes
a machine head 25 mounted with the improved impeller 24 inside, and the feed nozzle 1 and a discharge pipe 3 on an outer surface thereof,
an upper housing 21 and a lower housing 23 respectively mounted on upper and lower sides of a tip end of the machine head 25, and
a drive motor 22 mounted between the upper housing 21 and the lower housing 23 and configured to drive the rotary head 241 to rotate.

The machine head 25 includes
a circular cover 251 mounted on an outer surface of the mounting base 242,
a feed connector 253 disposed on an outer peripheral wall of the circular cover 251 and connected to the feed nozzle 1, and
a discharge connector 252 disposed on a tip end of the circular cover 251 and connected to the discharge pipe 3.

The feed connector 253 includes
a flange seat 2531 integrally formed on an outer side of the circular cover 251,
a connecting sleeve 2533 mounted on an outer surface of the flange seat 2531, and
a guide connector 2535 mounted on the feed nozzle 1 and movably engaged with the connecting sleeve 2533.

An outer wall of the flange seat 2531 is provided with a connecting groove 2532, an end of the connecting sleeve 2533 is provided with a screw-in clamping member 2534, the screw-in clamping member 2534 penetrates through the connecting groove 2532, the outer surface of the flange seat 2531 is provided with a limiting column 2537, and the limiting column 2537 is movably engaged with one side of the screw-in clamping member 2534.

An end of the guide connector 2535 is provided with an elastic clamping member 2536, and the elastic clamping member 2536 is movably engaged in an inner side wall of the connecting sleeve 2533.

The rotary head 241 is provided with a clamping groove 245 inside, an output end of the drive motor 22 is mounted with a transmission clamping member 26, and the transmission clamping member 26 is movably inserted into the clamping groove 245.

A rotary plate 244 is fixedly connected to the back surface of the rotary head 241, and the arc-shaped vortex blade 246 is integrally formed on an outer surface of the rotary plate 244.

A connecting pipe 243 is rotatably connected to an end of the guide nozzle 247, and fixedly mounted inside the discharge connector 252.

A working principle is as follows. When the device is in use, the mounting base 242 is mounted inside the circular cover 251 by the bolt, then the drive motor 22 is mounted inside the lower housing 23, the transmission clamping member 26 at the output end of the drive motor 22 is inserted into the clamping groove 245, then the upper housing 21 is mounted on an outer surface of the drive motor 22, and at this time, the connecting pipe 243 is fixedly mounted on the discharge connector 252, and the discharge pipe 3 is mounted at the end of the discharge connector 252.

Then, the screw-in clamping member 2534 at the end of the connecting sleeve 2533 is rotated to enter the inside of the connecting groove 2532, the inner side wall of the screw-in clamping member 2534 is movably engaged with the limiting column 2537, then one end of the guide connector 2535 is mounted on the feed nozzle 1, and the other end of the guide connector 2535 is engaged inside the connecting sleeve 2533 through the elastic clamping member 2536, thereby completing the mounting.

In use, by starting the drive motor 22, the output end of the drive motor 22 drives the transmission clamping member 26 to rotate. At this time, the transmission clamping member 26 drives the rotary head 241 to rotate, so that the rotary head 241 drives the arc-shaped vortex blade 246 to rotate, and the water drainage amount of the single-cavity arc-shaped vortex blade 246 is larger. During the rotation process, the water at one end of the feed nozzle 1 is suctioned, and then drained from one end of the guide nozzle 247 into the discharge pipe 3, so as to realize circulation pumping and drainage of a water body under water. During this process, a dust suction and filtration effect can be realized by mounting a filter member, and compared with the traditional multi-blade impeller, the improved impeller 24 has the stronger water throwing capability, the small volume, and the low cost.

The above shows and describes the basic principles, main features, and advantages of the present invention. Those skilled in the art should understand that the present invention is not limited to the above embodiment, the above embodiment and description are only illustrative of the principles of the present invention, various changes and improvements may be made to the present invention without departing from the spirit and scope of the present invention, and these changes and improvements fall within the scope of the claimed invention. The protection scope of the present invention is defined by the attached claims and their equivalents.

The present invention discloses an underwater vacuum cleaner impeller, and relates to the field of underwater vacuum cleaners. The underwater vacuum cleaner impeller includes a vacuum cleaner body, and an improved impeller mounted inside the vacuum cleaner body. The improved impeller includes a mounting base mounted inside the vacuum cleaner body, and a rotary head is rotatably disposed inside the mounting base. An arc-shaped vortex blade is mounted on a back surface of the rotary head, and a guide nozzle is mounted on an end of the arc-shaped vortex blade. In the underwater vacuum cleaner impeller, by starting a drive motor, the rotary head drives the arc-shaped vortex blade to rotate, and a water drainage amount of the single-cavity arc-shaped vortex blade is larger. During the rotation process, water at one end of a feed nozzle is suctioned, and then drained from one end of a guide nozzle into a discharge pipe, so as to realize circulation pumping and drainage of a water body under water. During this process, a dust suction and filtration effect can be realized by mounting a filter member, and compared with a traditional multi-blade impeller, the improved impeller has a stronger water throwing capability, a small volume, and a low cost.

What is claimed is:

1. An underwater vacuum cleaner impeller, comprising: a vacuum cleaner body (2); and an improved impeller (24) mounted inside the vacuum cleaner body (2), wherein
the improved impeller (24) includes
a mounting base (242) mounted inside the vacuum cleaner body (2),
a rotary head (241) mounted inside the mounting base (242) through a bearing,
an arc-shaped vortex blade (246) disposed on a back surface of the rotary head (241), and configured to rotate with the rotary head (241) to directionally push a fluid, and
a guide nozzle (247) mounted on an end of the arc-shaped vortex blade (246) by a bolt.

2. The underwater vacuum cleaner impeller according to claim 1, wherein the vacuum cleaner body (2) includes
a machine head (25) mounted with the improved impeller (24) inside, and a feed nozzle (1) and a discharge pipe (3) on an outer surface thereof,
an upper housing (21) and a lower housing (23) respectively mounted on upper and lower sides of a tip end of the machine head (25), and
a drive motor (22) mounted between the upper housing (21) and the lower housing (23) and configured to drive the rotary head (241) to rotate.

3. The underwater vacuum cleaner impeller according to claim 2, wherein the machine head (25) includes
a circular cover (251) mounted on an outer surface of the mounting base (242),
a feed connector (253) disposed on an outer peripheral wall of the circular cover (251) and connected to the feed nozzle (1), and
a discharge connector (252) disposed on a tip end of the circular cover (251) and connected to the discharge pipe (3).

4. The underwater vacuum cleaner impeller according to claim 3, wherein the feed connector (253) includes
a flange seat (2531) integrally formed on an outer side of the circular cover (251),
a connecting sleeve (2533) mounted on an outer surface of the flange seat (2531), and
a guide connector (2535) mounted on the feed nozzle (1) and movably engaged with the connecting sleeve (2533).

5. The underwater vacuum cleaner impeller according to claim 4, wherein an outer wall of the flange seat (2531) is provided with a connecting groove (2532), an end of the connecting sleeve (2533) is provided with a screw-in clamping member (2534), the screw-in clamping member (2534) penetrates through the connecting groove (2532), the outer surface of the flange seat (2531) is provided with a limiting column (2537), and the limiting column (2537) is movably engaged with one side of the screw-in clamping member (2534).

6. The underwater vacuum cleaner impeller according to claim 4, wherein an end of the guide connector (2535) is provided with an elastic clamping member (2536), and the elastic clamping member (2536) is movably engaged in an inner side wall of the connecting sleeve (2533).

7. The underwater vacuum cleaner impeller according to claim 2, wherein the rotary head (241) is provided with a clamping groove (245) inside, an output end of the drive motor (22) is mounted with a transmission clamping member (26), and the transmission clamping member (26) is movably inserted into the clamping groove (245).

8. The underwater vacuum cleaner impeller according to claim 7, wherein a rotary plate (244) is fixedly connected to the back surface of the rotary head (241), and the arc-shaped vortex blade (246) is integrally formed on an outer surface of the rotary plate (244).

9. The underwater vacuum cleaner impeller according to claim 3, wherein a connecting pipe (243) is rotatably connected to an end of the guide nozzle (247), and fixedly mounted inside the discharge connector (252).
